(19) United States
(12) Patent Application Publication
(10) Pub. No.: US 2024/0413292 A1
(43) Pub. Date: Dec. 12, 2024

(54) METHOD FOR MANUFACTURING BIPOLAR ELECTRODE LAMINATE AND METHOD FOR MANUFACTURING BIPOLAR BATTERY

(71) Applicant: TOYOTA JIDOSHA KABUSHIKI KAISHA, Toyota-shi (JP)

(72) Inventors: Yusuke KINTSU, Miyoshi-shi (JP); Takahiko NAKANO, Nagoya-shi (JP)

(73) Assignee: TOYOTA JIDOSHA KABUSHIKI KAISHA, Toyota-shi (JP)

(21) Appl. No.: 18/649,477

(22) Filed: Apr. 29, 2024

(30) Foreign Application Priority Data
Jun. 7, 2023 (JP) 2023-094115

(51) Int. Cl. H01M 4/04; H01M 4/02

(52) U.S. Cl. CPC H01M 4/0404; H01M 4/043; H01M 2004/029

(57) ABSTRACT

The present disclosure provides a method for manufacturing a bipolar electrode laminate in which a positive electrode active material layer and a negative electrode active material layer can each have a desired density and a small manufacturing process. The method of the present disclosure for manufacturing a bipolar electrode laminate comprising, providing a first electrode mixture, and the second electrode mixture comprising an electrolyte component, forming the first electrode mixture on a first surface of a current collector layer to form a first electrode active material layer precursor, and forming the second electrode mixture on a second surface of the current collector layer to form a second electrode active material layer precursor, pressing a laminate comprising the first electrode active material layer precursor, the current collector layer, and the second electrode active material layer precursor, and dissolving the electrolyte component with a solvent to produce an electrolytic solution.

### FIELD

The present disclosure relates to a method for manufacturing a bipolar electrode laminate and a method for manufacturing a bipolar battery.

### BACKGROUND

Conventionally, bipolar electrodes are known in which a positive electrode active material layer is provided on one surface of a current collector and a negative electrode active material layer is provided on the other surface.

For example, PTL 1 discloses a method for manufacturing a bipolar electrode including a step of applying a first electrode mixture slurry for forming a first active material layer to a first area of a first surface of a current collector, a step of applying a second electrode mixture slurry for forming a second active material layer to a second area on an inner peripheral side of the first area of a second surface of the current collector, a step of applying an electrical insulating agent slurry for forming an end electrical insulating layer to a third area of the second surface of the current collector that is in contact with the second area on an outer peripheral side of the second area, drying the first electrode mixture slurry, the second electrode mixture slurry, and the electrical insulating agent slurry, pressing the dried first electrode mixture slurry, second electrode mixture slurry, and electrical insulating agent slurry simultaneously to form the first active material layer, the second active material layer, and the end electrical insulating layer.

### CITATION LIST

### Patent Literature

[PTL 1] International Publication No. 2019/230323

### SUMMARY

### Technical Problem

In bipolar batteries, a positive electrode active material layer is desired to have a high density for high capacity, while a negative electrode active material layer may be desired to have a low to medium density for absorbing expansion and contraction of a negative electrode active material.

In manufacturing a bipolar battery, a layer for forming a positive electrode active material layer (hereinafter, a positive electrode active material layer precursor in the present disclosure) and a layer for forming a negative electrode active material layer (hereinafter, a negative electrode active material layer precursor in the present disclosure) may be made of different materials, and in that case, each of these layers has different flexibility. Therefore, when the negative electrode active material layer precursor and the positive electrode active material layer precursor are dried and pressed, the softer one of these is preferentially compressed, and a desired density may not be obtained in the negative electrode active material layer and the positive electrode active material layer formed by the pressing.

As a method for solving this problem, a method can be considered in which a bipolar electrode is manufactured by forming a positive electrode active material layer precursor on one surface of a positive electrode current collector layer, and a negative electrode active material layer precursor on one surface of a negative electrode current collector layer, forming each electrode active material layer by pressing each precursor, and bonding the surfaces of both current collector layers on which the electrode active material layer is not formed, facing each other. However, this method requires two pressing steps, resulting in more manufacturing processes.

An object of the present disclosure is to provide a method for manufacturing a bipolar electrode laminate in which a positive electrode active material layer and a negative electrode active material layer can each have a desired density and a small manufacturing process, and a method for manufacturing a bipolar battery comprising manufacturing such a bipolar electrode laminate.

### Solution to Problem

The present inventors have discovered that the above object can be achieved by the following means.

### <Aspect 1>

A method for manufacturing a bipolar electrode laminate having a first electrode active material layer, a current collector layer, and a second electrode active material layer in this order, the method comprising the following steps:
providing a first electrode mixture comprising a first electrode active material, and a first binder, and a second electrode mixture comprising a second electrode active material, a second binder, and an electrolyte component,
forming the first electrode mixture on a first surface of a current collector layer to form a first electrode active material layer precursor, and forming the second electrode mixture on a second surface of the current collector layer to form a second electrode active material layer precursor,
pressing a laminate comprising the first electrode active material layer precursor, the current collector layer, and the second electrode active material layer precursor, and
dissolving the electrolyte component in the second electrode active material layer with a solvent to produce an electrolytic solution after pressing.

### <Aspect 2>

The method according to Aspect 1, wherein the electrolyte component is a lithium salt.

### <Aspect 3>

The method according to Aspect 1 or 2, wherein the first electrode active material layer is a positive electrode active material layer, and the second electrode active material layer is a negative electrode active material layer.

### <Aspect 4>

A method for manufacturing a bipolar battery, comprising manufacturing the bipolar electrode laminate by the method according to any one of Aspects 1 to 3.

### Advantageous Effects of Invention

According to the present disclosure, it is possible to provide a method for manufacturing a bipolar electrode laminate in which a positive electrode active material layer and a negative electrode active material layer can each have a desired density and a small manufacturing process, and a method for manufacturing a bipolar battery comprising manufacturing such a bipolar electrode laminate.

### BRIEF DESCRIPTION OF DRAWINGS

FIG. 1 is a cross-sectional view showing a laminate before dissolving an electrolyte component with a solvent.

FIG. 2 is a cross-sectional view showing a bipolar electrode laminate after dissolving an electrolyte component with a solvent.

### DESCRIPTION OF EMBODIMENTS

Hereinafter, embodiments of the present disclosure will be described in detail. It should be noted that the present disclosure is not limited to the following embodiments, and various modifications can be made thereto within the scope of the disclosure.

### <<Manufacturing Method for Bipolar Electrode Laminates>>

The method of the present disclosure for manufacturing a bipolar electrode laminate having a first electrode active material layer, a current collector layer, and a second electrode active material layer in this order comprising, providing a first electrode mixture comprising a first electrode active material, and a first binder, and a second electrode mixture comprising a second electrode active material, a second binder, and an electrolyte component, forming the first electrode mixture on a first surface of a current collector layer to form a first electrode active material layer precursor, and forming the second electrode mixture on a second surface of the current collector layer to form a second electrode active material layer precursor, pressing a laminate comprising the first electrode active material layer precursor, the current collector layer, and the second electrode active material layer precursor, and dissolving the electrolyte component in the second electrode active material layer with a solvent to produce an electrolytic solution after pressing.

In the case where a bipolar electrode laminate is collectively formed by pressing a laminate in which an electrode active material precursor is formed on both surfaces of a current collector layer, the present inventors have found that a densification of an electrode active material layer due to pressing can be suppressed by adding an electrolyte component to an electrode active material layer precursor in which a density is desired to be low and pressing, and then adding a solvent to dissolve the electrolyte component.

Further, according to the method of the present disclosure, by dissolving the electrolyte within the battery case, the obtained solution can be utilized as an electrolytic solution for the battery as it is.

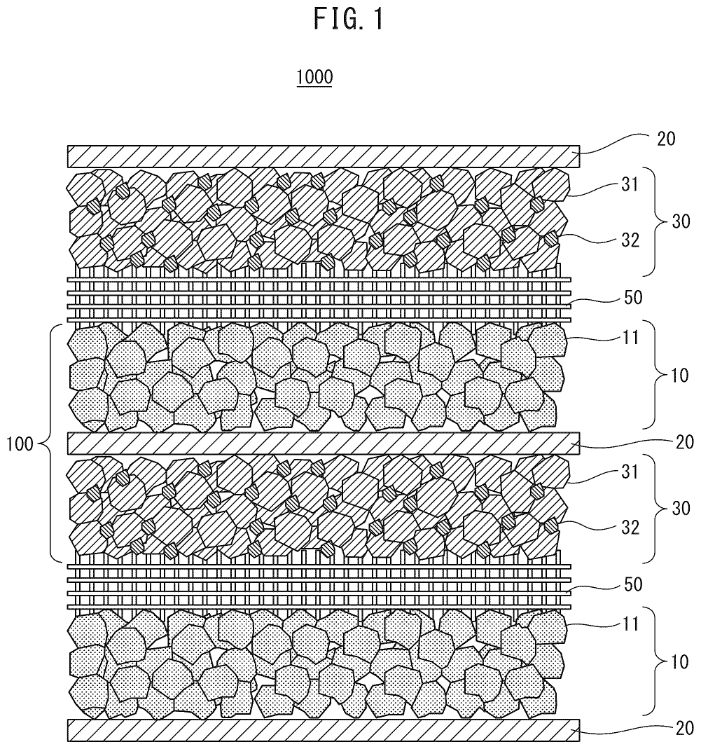

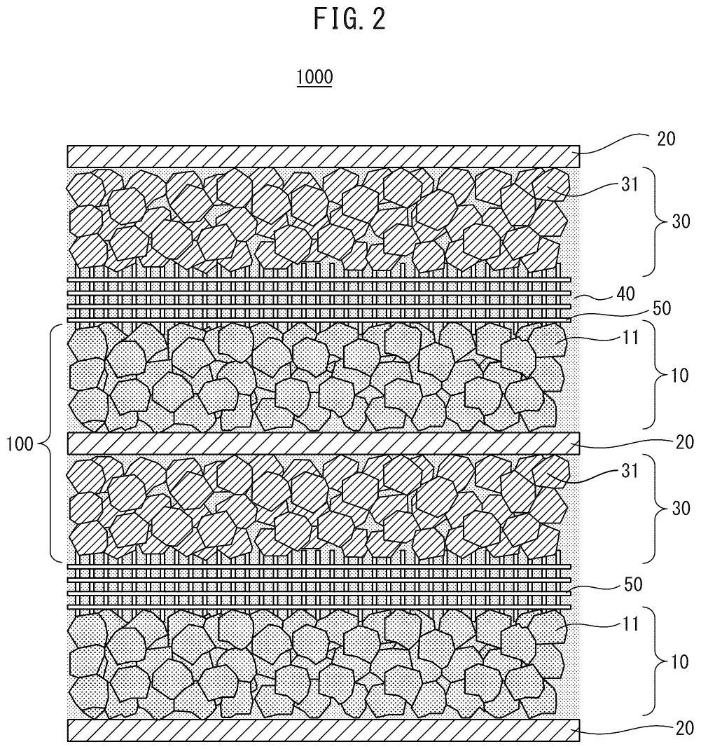

Referring to the drawings, a method of the present disclosure for manufacturing a bipolar electrode laminate is described. FIG. 1 is a cross-sectional view showing a laminate before dissolving an electrolyte component with a solvent. As shown in FIG. 1, the second electrode active material layer comprises a second electrode active material 31 and an electrolyte component 32. FIG. 2 is a cross-sectional view showing a bipolar electrode laminate after dissolving the electrolyte component 32 with a solvent. As shown in FIG. 2, the electrolyte component 32 is dissolved with the solvent to produce an electrolytic solution 40. Thereby, it is possible to suppress the densification of the second electrode active material layer due to pressing. In the drawings, the first binder and the second binder are omitted.

### <Provision of Electrode Mixture>

The method of the present disclosure comprises providing a first electrode mixture comprising a first electrode active material, and a first binder, and a second electrode mixture comprising a second electrode active material, a second binder, and an electrolyte component.

### (First Electrode Mixture)

The first electrode mixture includes a first electrode active material and a first binder. Further, the first electrode mixture optionally includes a first thickener and a first conductive aid. By mixing these materials, the first electrode mixture can be provided.

The first electrode active material is a positive electrode active material or a negative electrode active material. Among known active materials, two materials having different potentials (charging and discharging potentials) for occluding and releasing predetermined ions are selected, and a material exhibiting a noble potential can be used as a positive electrode active material, and a material exhibiting a base potential can be used as a negative electrode active material to be described later, respectively.

Any known active material may be used as the positive electrode active material. For example, when a lithium ion battery is composed, various lithium-containing complex oxides such as lithium cobaltate, lithium nickelate, LiNi_{1/3} Co_{1/3} Mn_{1/3} O₂, lithium manganate, spinel-based lithium compounds can be used as the positive electrode active material. Further, lithium-iron phosphate (LFP) can be used as an olivine-type positive electrode active material. The positive electrode active material may be, for example, particulate, and the size thereof is not particularly limited.

Any known active material may be used as the negative electrode active material. For example, when a lithium ion battery is composed, As the negative electrode active material, silicone-based active materials such as silicone, silicon alloy, and silicon oxide; carbon-based active materials such as graphite and hard carbon; various oxide-based active materials such as lithium titanate; and metallic lithium and lithium alloy can be used. The negative electrode active material may be, for example, particulate, and the size thereof is not particularly limited.

Examples of the first binder include a butadiene rubber (BR) based binder, a butylene rubber (IIR) based binder, a styrene butadiene rubber (SBR) based binder, an acrylate butadiene rubber (ABR) based binder, a polyvinylidene fluoride (PVdF) based binder, a polytetrafluoroethylene (PTFE) based binder, and the like.

Examples of the first conductive aid include carbon materials such as acetylene black, ketchen black, and carbon nanotubes, and metallic materials such as nickel, aluminum, and stainless steel. The conductive aid may be, for example, particulate or fibrous, and the size thereof is not particularly limited.

Examples of the first thickener include, carboxymethylcellulose, but are not limited thereto.

### (Second Electrode Mixture)

The second electrode mixture includes a second electrode active material, a second binder, and an electrolyte component. Further, the second electrode mixture optionally includes a second thickener and a second conductive aid. By mixing these materials, a second electrode mixture can be provided.

The second electrode active material is a material for forming an electrode active material layer different from the first electrode active material among the positive electrode active material and the negative electrode active material. In other words, if the first electrode active material is a positive electrode active material, the second electrode active material is a negative electrode active material, and if the first electrode active material is a negative electrode active material, the second electrode active material is a positive electrode active material.

The above descriptions relating to the first electrode active material of the present disclosure can be referenced regarding the second electrode active material.

For the second binder, reference may be made to the above description regarding the first binder of the present disclosure. The above descriptions relating to the first binder of the present disclosure can be referenced regarding the second binder.

As the electrolyte component, any material that can function as an electrolyte for a bipolar battery can be used. For example, when a lithium ion battery is composed, the electrolyte component may be a lithium salt. Examples of the lithium salt include lithium bis (fluorosulfonyl) imide (LiFSI), lithium trifluoromethanesulfonate (LiOTF), and the like.

The above descriptions relating to the first thickener and the first conductive aid of the present disclosure can be referenced regarding the second thickener and the second conductive aid.

### <Formation of Electrode Active Material Layer Precursor>

The method of the present disclosure comprises forming the first electrode mixture on a first surface of a current collector layer to form a first electrode active material layer precursor, and forming the second electrode mixture on a second surface of the current collector layer to form a second electrode active material layer precursor. It is noted that, in the present disclosure, the term “electrode active material precursor” means a layer capable of forming an electrode active material layer by pressing.

### (Current Collector Layer)

In the present disclosure, a “current collector layer” means a bipolar current collector layer, that is, a current collector layer in which a positive electrode active material layer is formed on one surface thereof and a negative electrode active material layer is formed on the other surface.

The current collector layer may be in the form of foil, plate, mesh, punching metal, foam, or the like. The collector layer may be composed of metal foil or metal mesh. In particular, metal foil has excellent handling properties. The collector layer may consist of multiple foils. When the electric collector layer is composed of multiple metal foils, it may have some layer between the multiple metal foils.

When the current collector layer is made of metal, metals constituting the current collector layer include Cu, Ni, Cr, Au, Pt, Ag, Al, Fe, Ti, Zn, Co, stainless-steel, and the like.

When the current collector layer consists of multiple metal foils, for example, the metal foil can be bonded by adhesive to form the current collector layer.

The thickness of the electrolyte layer is not particularly limited. For example, it may be 0.1 μm or greater, or 1 μm or greater, and may be 1 mm or less, or 100 μm or less.

As a method for forming an electrode mixture on the surface of the current collector layer, a method of applying a paste-like electrode mixture and drying it is exemplified, but the method is not limited thereto.

### <Pressing the Laminate>

The method of the present disclosure comprises pressing a laminate comprising the first electrode active material layer precursor, the current collector layer, and the second electrode active material layer precursor. For example, it can be pressed using a roll press machine.

The pressure for pressing the laminate, may be 1 kN/cm or greater, 3 kN/cm or greater, 5 kN/cm or greater, 6 kN/cm or greater, or 7 kN/cm or greater, and may be 15 kN/cm or less, 13 kN/cm or less, 11 kN/cm or less, 10 kN/cm or less, or 9 kN/cm or less.

### <Dissolution of Electrolyte Components>

The method of the present disclosure comprises dissolving the electrolyte component in the second electrode active material layer with a solvent to produce an electrolytic solution after pressing.

As the solvent, carbonates, esters, ethers, nitriles, sulfones, lactones, and the like can be used. Examples thereof include ethylene carbonate (EC), propylene carbonate (PC), diethyl carbonate (DEC), dimethyl carbonate (DMC), ethyl methyl carbonate (EMC), 1,2-dimethoxyethane, 1,2-diethoxyethane, tetrahydrofuran, 2-methyltetrahydrofuran, dioxane, 1,3-dioxolane, diethylene glycol, dimethyl ether, ethylene glycol, acetonitrile, propionitrile, nitromethane, N,N-dimethylformamide, dimethyl sulfoxide, sulfolane, γ-butyrolactone, and the like.

The bipolar electrode laminate manufactured by the method of the present disclosure has the first electrode active material layer, the current collector layer, and the second electrode active material layer in this order.

### <First Electrode Active Material Layer>

In the method of the present disclosure, the first electrode active material layer may be a positive electrode active material layer or a negative electrode active material, but is preferably a positive electrode active material layer. In this case, the first electrode active material, and the first electrode mixture may be a positive electrode active material and a positive electrode mixture, respectively.

The density of the first electrode active material layer may be 2.00 g/cc or greater, 2.05 g/cc or greater, or 2.10 g/cc or greater, and may be 2.25 g/cc or less, 2.20 g/cc or less, or 2.15 g/cc or less.

The difference between the density of the first electrode active material layer and the density of the first electrode active material layer precursor may be 0.20 g/cc or greater, 0.25 g/cc or greater, or 0.30 g/cc or greater, and may be 0.45 g/cc or less, 0.40 g/cc or less, or 0.35 g/cc or less.

As the density, a value calculated from the basis weight of the active material and the actual measured value of its thickness can be adopted.

The content of each component in the first electrode active material layer may be the same as the conventional one.

The shape of the first electrode active material layer may also be the same as the conventional one. From the viewpoint that the battery can be more easily constructed, a sheet-like first electrode active material layer may be used.

The thickness of the first electrode active material layer is not particularly limited. For example, it may be 0.1 μm or greater and 2 mm or less. The lower limit may be 1 μm or greater, and the upper limit may be 1 mm or less.

### <Current Collector Layer>

The above descriptions relating to the current collector layer of the present disclosure can be referenced regarding the current collector layer.

### <Second Electrode Active Material Layer>

In the method of the present disclosure, the second electrode active material layer may be a positive electrode active material layer or a negative electrode active material layer, but is preferably a negative electrode active material layer. In this case, the second electrode active material, and the second electrode mixture may be a negative electrode active material and a negative electrode mixture, respectively.

The density of the second electrode active material layer may be 1.00 g/cc or greater, 1.05 g/cc or greater, or 1.10 g/cc or greater, and may be 1.25 g/cc or less, 1.20 g/cc or less, or 1.15 g/cc or less.

The difference between the density of the second electrode active material layer and the density of the second electrode active material layer precursor may be 0.01 g/cc or greater, 0.05 g/cc or greater, or 0.08 g/cc or greater, and may be 0.20 g/cc or less, 0.15 g/cc or less, or 0.12 g/cc or less.

The rate of increase from the density of the second electrode active material layer precursor to the density of the second electrode active material layer may be 0.10% or greater, 1.0% or greater, 3.0% or greater, 5.0% or greater, 7.0% or greater, 8.0% or greater, 9.0% or greater, or 9.5% or greater, and may be 29.0% or less, 25.0% or less, 20.0% or less, 17.0% or less, 15.0% or less, 14.0% or less, 13.0% or less, 12.0% or less, 11.0% or less, or 10.0% or less.

The content of each component in the second electrode active material layer may be the same as the conventional one.

The shape of the second electrode active material layer may also be the same as the conventional one. From the viewpoint that the battery can be more easily constructed, a sheet-like second electrode active material layer may be used.

The thickness of the second electrode active material layer is not particularly limited. For example, it may be 0.1 μm or greater and 2 mm or less. The lower limit may be 1 μm or greater, and the upper limit may be 1 mm or less.

### <<Manufacturing Method for Bipolar Battery>>

The method of the present disclosure for manufacturing a bipolar battery comprises manufacturing the bipolar electrode laminate.

### <Manufacturing of Bipolar Electrode Laminate>

The above descriptions relating to the manufacturing of bipolar electrode laminate of the present disclosure can be referenced regarding the manufacturing of bipolar electrode laminate.

### <Housing in Battery Case, and the Like>

The bipolar electrode laminate and separator layer can be alternately laminated and housed in a battery case and impregnated with electrolytic solution to obtain a bipolar battery. Specifically, the bipolar battery of the present disclosure can be obtained by housing the bipolar electrode laminate and separator layer in the battery case, and filling a solvent dissolving the electrolyte component in the second electrode active material layer in the battery case to produce an electrolyte solution, and immersing the bipolar electrode laminate and the separator layer in an electrolytic solution and sealing the bipolar electrode laminate, the separator layer, and the electrolytic solution in the battery case.

The separator layer may be an electrically insulated nonwoven fabric or porous film. Examples of the porous film include films made of resins such as polyethylene (PE) and polypropylene (PP).

### EXAMPLES

### <<Preparation of Bipolar Electrode Laminate>>

### <Formation of Current Collector Layer>

### Example 1

An aluminum foil and a copper foil were bonded together by an adhesive (base resin: olefinic resin, curing agent: isocyanate base), and the adhesive was subjected to a curing reaction to form a current collector layer.

### <Formation of Positive Active Material Layer Precursor and Negative Active Material Layer Precursor>

Lithium iron phosphate (LFP) as a positive electrode active material, styrene butadiene rubber (SBR) as a binder, carboxymethylcellulose (CMC) as a thickener, carbon nanotube (CNT) as a conductive aid, and water as a solvent were mixed to obtain a positive electrode mixture paste. The obtained positive electrode mixture paste was applied to the aluminum foil surface of the above current collector layer to form a positive electrode active material layer precursor. Further, graphite as a negative electrode active material, SBR as a binder, CMC as a thickener, CNT as a conductive aid, lithium bis (fluorosulfonyl) imide (LiFSI) as an electrolyte component (manufactured by Nippon Catalyst Co., Ltd., Ionel), and water as a solvent were mixed to obtain a negative electrode mixture paste. The obtained negative electrode mixture paste was applied to the copper foil surface of the above current collector layer to form a negative electrode active material layer precursor. The positive electrode active material layer precursor and the negative electrode active material layer precursor formed on the current collector layer were dried to obtain a laminate.

### <Pressing the Laminate>

The obtained laminate was pressed with a linear pressure of 8 kN/cm.

### <Dissolution of Electrolyte Components>

The pressed laminate was washed with water to dissolve and remove LiFSI. Thereby, a bipolar electrode laminate was prepared.

### Comparative Example 1

A bipolar electrode laminate was prepared in the same manner as in Example 1, except that the electrolyte component was not used in forming the negative electrode active material layer precursor, and that the dissolution of the electrolyte component was not performed.

### <<Evaluation>>

### <Density>

The densities of the positive electrode active material layer precursor and the positive electrode active material layer, and the negative electrode active material layer precursor and the negative electrode active material layer were measured. As the density, a value calculated from the basis weight of the active material and the actual measured value of its thickness was adopted.

<<Results>>

The calculation results of the density are shown in Table 1

TABLE 1

| | Density[g/cc] | | | |
|---|---|---|---|---|
| | Positive electrode | Positive electrode | Negative electrode | Negative electrode |
| | active material | active material | active material | active material |
| | layer precursor | layer | layer precursor | layer |
| Example 1 | 1.80 | 2.12 | 1.01 | 1.11 |
| Comparative | 1.80 | 2.11 | 1.02 | 1.32 |
| Example 1 | | | | |

As shown in Table 1, in the method of the present disclosure, the densification of the negative electrode active material layer due to pressing can be suppressed, and a positive electrode active material layer can be selectively densified.

### REFERENCE SIGNS LIST

10 First electrode active material layer
11 First electrode active material
20 Current collector layer
30 Second electrode active material layer
31 Second electrode active material
32 Electrolyte component
40 Electrolytic solution
50 Separator
100 Bipolar electrode
1000 Bipolar battery

1. A method for manufacturing a bipolar electrode laminate having a first electrode active material layer, a current collector layer, and a second electrode active material layer in this order, the method comprising the following steps:
providing a first electrode mixture comprising a first electrode active material, and a first binder, and a second electrode mixture comprising a second electrode active material, a second binder, and an electrolyte component,
forming the first electrode mixture on a first surface of a current collector layer to form a first electrode active material layer precursor, and forming the second electrode mixture on a second surface of the current collector layer to form a second electrode active material layer precursor,
pressing a laminate comprising the first electrode active material layer precursor, the current collector layer, and the second electrode active material layer precursor, and
dissolving the electrolyte component in the second electrode active material layer with a solvent to produce an electrolytic solution after pressing.

2. The method according to claim 1, wherein the electrolyte component is a lithium salt.

3. The method according to claim 1, wherein the first electrode active material layer is a positive electrode active material layer, and the second electrode active material layer is a negative electrode active material layer.

4. A method for manufacturing a bipolar battery, comprising manufacturing the bipolar electrode laminate by the method according to claim 1.
